(19) United States
(12) Patent Application Publication
(10) Pub. No.: US 2010/0070430 A1
(43) Pub. Date: Mar. 18, 2010

(54) COMPARING FINANCIAL PRODUCTS

(75) Inventor: George Favvas, Montreal (CA)

Correspondence Address: Workman Nydegger;1000 Eagle Gate Tower, 60 East South Temple, Salt Lake City, UT, 84111, US

(73) Assignee: SMARTHIPPO, INC., Montreal (CA)

(21) Appl. No.: 12/561,187

(22) Filed: Sep. 16, 2009

Related U.S. Application Data
(60) Provisional application No. 61/097,402, filed on Sep. 16, 2008.

(51) Int. Cl. G06Q 40/00; G06Q 30/00

(52) U.S. Cl. 705/36 R; 707/E17.017; 707/E17.044

(57) ABSTRACT

The present invention extends to methods, systems, and computer program products for comparing financial products. Consumers collaborate to assist one another in identifying favorably priced financial products that meet their criteria. Pricing for financial products can be tailored to a consumer's eligibility (e.g., based on financial profile). Thus, a consumer is presented with more relevant financial products. When insufficient data is available to identify financial products for a consumer based on a consumer's profile, data enhancement techniques, including interpolation, extrapolation, and grouping can be used to used facilitate financial product identification and pricing.

### CROSS-REFERENCE TO RELATED APPLICATIONS

This application claims priority to U.S. Provisional Patent Application Ser. No. 61/097,402, filed Sep. 16, 2008, and entitled “System And Method For Collaborative Comparison of Financial Products By Consumers”, which is herein incorporated by reference in its entirety.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Pricing for many financial products is often delivered using computer networks. For example, a potential buyer (e.g., an individual, business, organization, etc.) can access a Web site that provides quotes for financial products. The potential buyer can enter financial product information (e.g., a type of financial product) along with profile (e.g., personal) information for into the Web site. The Web site then identifies financial products (e.g., supplied by one or more financial service providers) that match the financial product information and provides a quote (e.g., pricing information, terms, etc.) for those financial products based the profile information

Unfortunately, these and other similar types computerized quote delivery mechanism for financial products are problematic for a number of reasons. There are many different profile criteria for a potentially buyer that affect the pricing of a financial product. However, the uniqueness of these criteria makes it difficult to objectively compare the quotes they have received with quotes received by other users. Further, the potentially buyer may be unaware that a provided quote does not indicate the best available price and/or that there is room for negotiation with respect to a provided quote.

Further, in most, if not all, computerized quote delivery mechanisms, potential buyers are subject to malicious tactics on the part of the service provider. For example, potential buyers have no way to independently verify that pricing and/or other information in a quote is accurate. As such, potential buyers can fall prey to “bait and switch” tactics designed to entice a potentially buyer with pricing or other terms that are not in fact available to them, and perhaps not available to anyone.

### BRIEF SUMMARY

The present invention extends to methods, systems, and computer program products for comparing financial products. Embodiments of the invention include comparing financial products for a potential consumer. A computer system receives a query from a potential consumer of a financial product. The query contains query terms that identify a type of financial product and include profile information for the potential consumer of the type of financial product. The profile information includes information relevant to selecting pricing and terms for the type of financial product.

The computer system compares the query terms to financial product quote data stored in a database. The financial product quote data is for a plurality of financial products of the financial product type being offered by plurality of different service providers. The computer system identifies one or more financial products responsive to the query based on the comparison. The one or more financial products are selected from among the plurality of financial products of the financial product type.

The computer system formulates a quote list of financial product quotes for the one or more identified financial products. The quote list includes a financial product quote for each of the one or more identified financial products. The computer system uses one or more of information supplied by other consumers and information from transactions generated by other consumers to customize the quote list of financial product quotes. Customizing the quote list includes at least one of: customizing quote details for a financial product quote, appending consumer ratings to the financial quotes, and customizing a presentation order for the financial product quotes. The computer system returns the customized quote list to the potential consumer in response to the query.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates comparing financial products

FIG. 1B illustrates a more detailed view of portions of the example computer architecture of FIG. 1A for inputting information for financial products.

FIG. 1C illustrates a more detailed view of a portion of the example computer architecture of FIG. 1A for providing financial product quotes to a potential consumer.

FIG. 2 illustrates a flow chart of an example method for comparing financial products for a potential consumer.

FIG. 3A illustrates an example interface for entering profile information.

FIG. 3B illustrates an example interface for presenting a list of financial product quotes.

FIG. 4 illustrates an example interface for a service provider to enter pricing information for financial products

FIG. 5 illustrates an example interface for a consumer to enter pricing information for a financial product.

FIG. 6 illustrates an example of consumer profile information being placed into buckets.

### DETAILED DESCRIPTION

The present invention extends to methods, systems, and computer program products for comparing financial products. Embodiments of the invention include comparing financial products for a potential consumer. A computer system receives a query from a potential consumer of a financial product. The query contains query terms that identify a type of financial product and include profile information for the potential consumer of the type of financial product. The profile information includes information relevant to selecting pricing and terms for the type of financial product.

The computer system compares the query terms to financial product quote data stored in a database. The financial product quote data is for a plurality of financial products of the financial product type being offered by plurality of different service providers. The computer system identifies one or more financial products responsive to the query based on the comparison. The one or more financial products are selected from among the plurality of financial products of the financial product type.

The computer system formulates a quote list of financial product quotes for the one or more identified financial products. The quote list includes a financial product quote for each of the one or more identified financial products. The computer system uses one or more of information supplied by other consumers and information from transactions generated by other consumers to customize the quote list of financial product quotes. Customizing the quote list includes at least one of: customizing quote details for a financial product quote, appending consumer ratings to the financial quotes, and customizing a presentation order for the financial product quotes. The computer system returns the customized quote list to the potential consumer in response to the query.

Generally, embodiments of the invention facilitate collaboration between consumers to help each other locate favorable pricing for financial products. A consumer can search for available financial products that meet their criteria. Pricing can be supplied by service providers and/or by other consumers. Consumers can be grouped with other consumers having a similar financial provider in buckets so that the consumers can access the most favorable pricing obtained by consumers in their bucket. When insufficient data is available for pricing a financial product for a consumer based on their financial profile, additional data can be interpolated and/or extrapolated from existing data such that the consumer can be provided with likely pricing options. Consumers can review and rate service providers that offer financial products and can review and rate input providers that post information about financial products.

Embodiments of the present invention may comprise or utilize a special purpose or general-purpose computer including computer hardware (e.g., one or more processors and system memory), as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

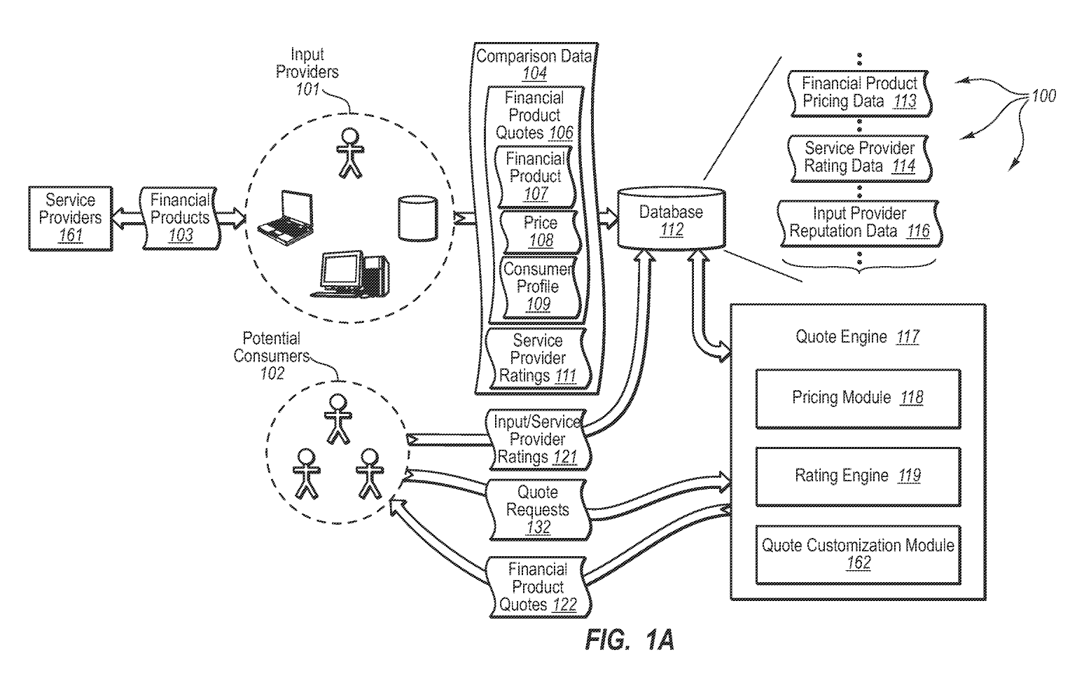

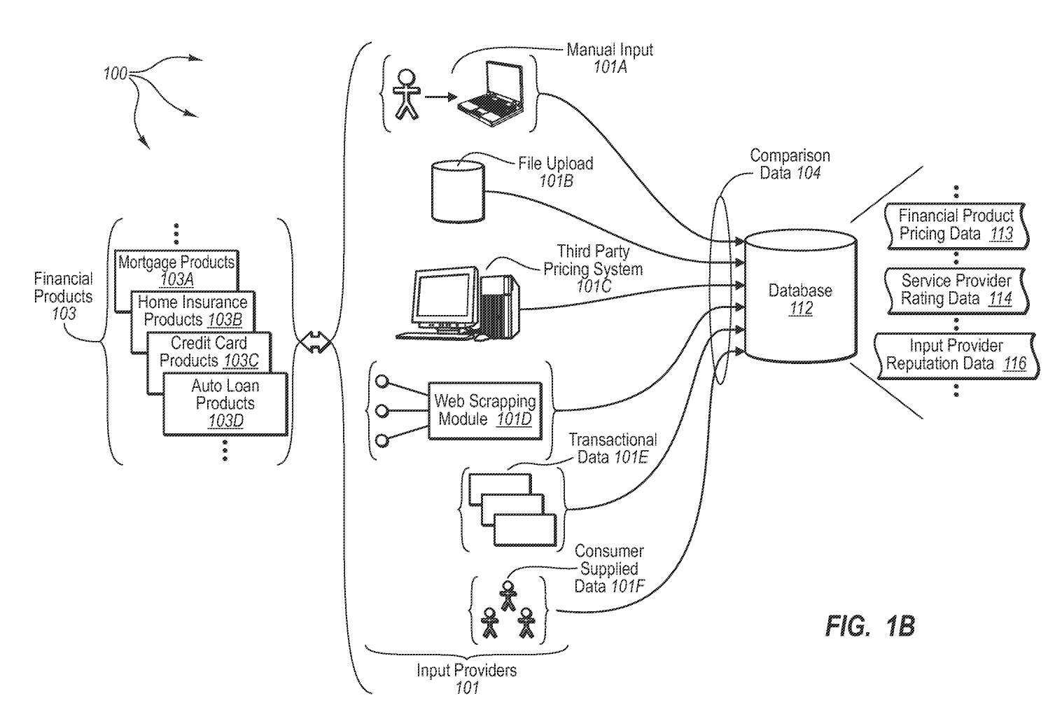

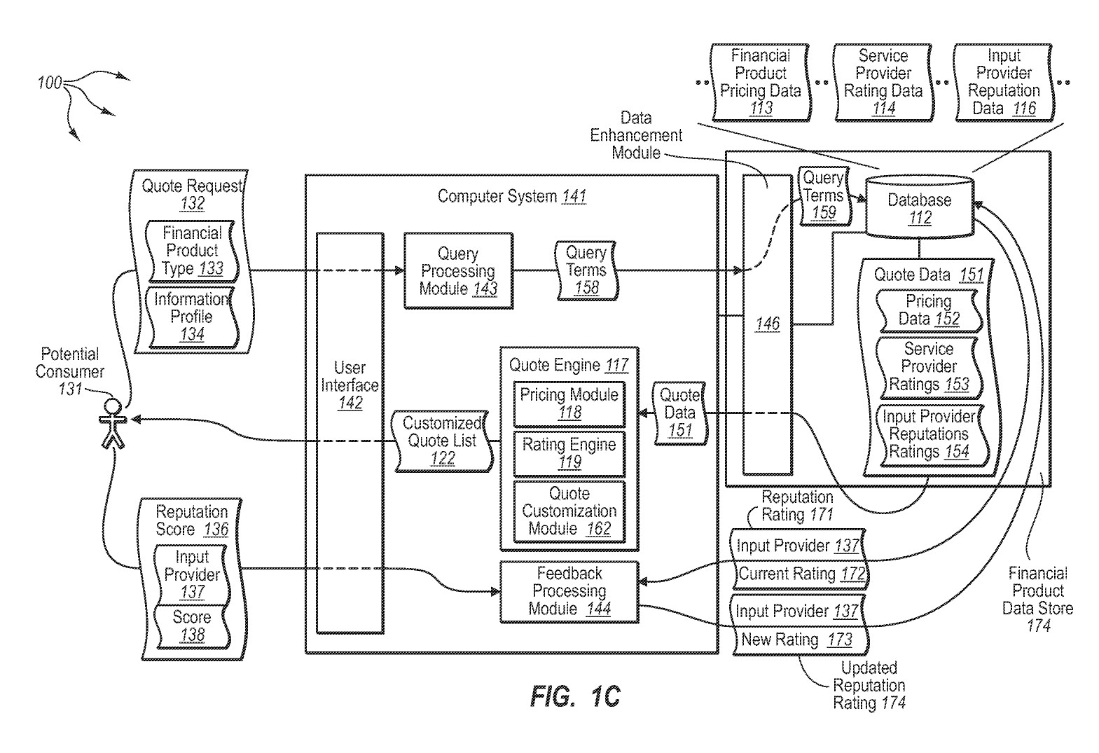

FIG. 1A illustrates an example computer architecture 100 that facilitates comparing financial products. Referring to FIG. 1A, computer architecture 100 includes service providers 161, input providers 101, database 112, quote engine 117, and potential consumers 102. Each of the depicted components is connected to one another over (or is part of) a network, such as, for example, a Local Area Network (“LAN”), a Wide Area Network (“WAN”), and even the Internet. Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, service providers 161 represent a plurality of different entities that offer financial products 103, such as, for example, mortgages, home insurance, credit cards, auto loans, life insurance, auto insurance, property insurance, malpractice insurance, health insurance, etc., for sale. Input providers 101 can enter comparison data for financial products 103 offered for sale by service providers 161 into database 112. In some embodiments, one or more service providers are also input providers. That is, service providers can input comparison data for financial products 103 they offer for sale into database 112.

Thus, input providers 101 can include financial product consumers, financial product service providers, administrators of database 112, third party pricing systems, automated software components (e.g., spiders or bots), captured transactional data, etc. Generally, comparison data 104 represents comparison data for a plurality of different financial products 103 offered for sale by services providers 161. Comparison data 104 can be accumulated over time as input providers 101 acquire information (e.g., quotes) for financial products 103 and enter the information (e.g., quotes) into database 112.

Comparison data 104 can include financial product quotes 106 and service provider ratings 111. Each quote in financial product quotes 106 can include a financial product 107, a price 108, and a consumer profile 109. This information represents that financial product 107 was offered for sale at price 108 to a consumer having consumer profile 109. Consumer profile 109 can include a variety of different types of consumer information including, but not limited to: sex, age, credit score, location, loan to value ratio, debt to income ratio, loan amount, income, etc. Further, depending on the type of financial product, different types of profile information may be more or less relevant. For example, a loan to value ratio is not applicable to an offer to sell life insurance.

Service provider ratings 111 indicate how consumers of financial products 103 have rated service providers 161. Service provider ratings 111 can measure consumer satisfaction for interactions with a service provider. Service provider ratings 111 can rate service providers in any of a variety of different ways, such as, for example, on continuum (e.g., from 1-10), using discrete ratings (e.g., one star, two stars, three stars, four stars) etc. When a consumer has a positive experience with a service provider, the consumer can give the service provider a higher rating (e.g., four stars). On the other hand, when a consumer has a negative experience with a service provider, the consumer can give the service provider a lower rating (e.g., one star). Text-based comments can also be submitted for service providers.

Accordingly, comparison data 104 from different service providers among service providers 122 and relating to different financial products among financial products 103 is accumulated over time and stored in database 112. As such, database 112 essentially serves as a central common location that consumers can access to obtain quotes for a plurality of different financial products offered by a plurality of different service providers. Database 112 can store comparison data 104 in different formats, locations, tables, directories, etc. to facilitate efficient querying by potential consumers of financial products 103. In some embodiments, comparison data 104 is stored as financial product pricing data 113 and service provider rating data 114.

Database 112 can also store input provider reputation data 116, indicating the trustworthiness of comparison data entered by input providers 101. Each input provider in input providers 101 can have a reputation rating indicative of the trustworthiness of the data the input provider has entered into database 112. Thus, when a particular input provider enters inaccurate or untrue comparison data for a financial product, consumers can indicate a lower reputation rating for the particular input provider. On the other hand, when a particular input provider enters accurate and true comparison data for a financial product, consumers can indicate a higher reputation rating for the particular input provider. Accordingly, a community of users can collaboratively police input data sources and provide a greater measure of accuracy for data stored in database 112. Text-based comments can also be submitted for input providers.

Scoring for input provider reputation ratings can be maintained using mechanisms similar to those used to maintain service provider ratings.

Although virtually any rating system can be used for service provider and input provider reputations ratings, in some embodiments a rating system is simple enough that a potential new consumer can easily obtain meaningful information from a rating for a service provider or input provider. For example, a presented rating for a service provider can represent the average of individual ratings received from a plurality of different consumers that have interacted with the service provider. Similarly, a presented reputation rating for an input provider can represent the average of individual ratings received from a plurality of different consumers that have judged the trustworthiness of comparison data supplied by the input provider.

As depicted, quote engine 117 includes pricing module 118, rating engine 119, and quote customization module 162. Generally, quote engine 117 is configured to interoperate with database 112 to provide potential consumers 102 with financial product quotes. From time to time, potential consumers 102 can submit quote requests 132 to quote engine 117. The quote requests can include consumer profile information that quote engine 117 can use to identify financial products for the potential consumers. Based on profile information quote engine can identify financial products that are more likely to be of interest to potential consumers 102.

Upon receiving a quote request, pricing module 118 can scan financial product pricing data 113 and formulate a list of offered financial products corresponding to consumer profile information, including pricing information for the offered financial products. For each offered financial product, rating engine 119 can then identify the service provider offering the financial product and the input provider that entered the offered financial product into database 112. When appropriate, quote customization module 162 can perform one or more customizations to the list of offered financial products, including but not limited to customizing quote details for one or more financial products, appending service provider ratings and/or input provider ratings to the list of offered financial products, and customizing the presentation order for the list of offered financial products.

Quote engine 117 can return financial product quotes 122 back to potentially consumers 102. Financial product quotes 122 can include a (possibly customized) list of financial products having a higher likelihood of being of interest to potential consumers 102 based on received profile information. Financial product quotes 122 can include pricing information as well as other terms for one or more of financial products 103.

After reviewing financial product quotes 122, potential consumers 102 may decide to access computer systems under the control of a service provider (e.g., the service provider's Web site) to verify and/or obtain additional information related to a financial product. A potential consumer can also further interact with a service provider through additional communication mechanisms, such as, for example, telephonically communication, message groups, text messaging, electronic mail, etc. to obtain additional information about a financial product. A potential consumer can also purchase a financial product through a service provider when appropriate.

At any point in time after verifying and/or obtaining additional information, a potential consumer can submit a rating for a service provider and/or an input provider associated with a financial product quote. For example, potential consumers 102 can submit input/service provider ratings 121 to database 112. Input/service provider ratings 121 can be used to update service provider rating data 114 and/or input provider reputation data 116 as appropriate.

A potential consumer can submit a service provider rating indicative of their experience interacting with a service provider. For example, if a potential consumer has a positive experience interacting with a service provider, the potential consumer can submit a service provider rating that reflects the positive experience interacting with the service provider. On the other hand, if a potential consumer has a negative experience interacting with a service provider, the potential consumer can submit a service provider rating that reflects the negative experience interacting with the service provider.

Likewise, a potential consumer can submit an input provider reputation rating indicative of the trustworthiness of financial product information entered (into database 112) by an input provider. For example, if information about a financial product appears to have been accurately represented in financial product quotes 122, the potential consumer can submit an input provider rating indicating that the input provider is trustworthy. On the other hand, if information about a financial product appears to have been inaccurately represented or is simply false, the potential consumer can submit an input provider rating indicating that the input provider is not trustworthy. If the input provider is also a service provider, the submitted reputation rating for the input provider can also be used to adjust (e.g., either up or down) the service provider rating for the service provider.

FIG. 1B illustrates a more detailed view of portions of computer architecture 100 for inputting information for financial products. As depicted, in FIG. 1B, financial products 103 include mortgage products 103A, home insurance products 103B, credit card products 103C, and auto loan products 103D. Also as depicted, input providers 101 include manual input 101A, file upload 101B, third party pricing system 101C, Web scrapping module 101D, transactional data 101E, and consumer supplied data 101F. Each of the input providers in input providers 101 can include one or more mechanisms for entering information about financial products in financial products 103 into database 112. Accordingly, input providers 101 can collectively enter comparison data 104 into database 112.

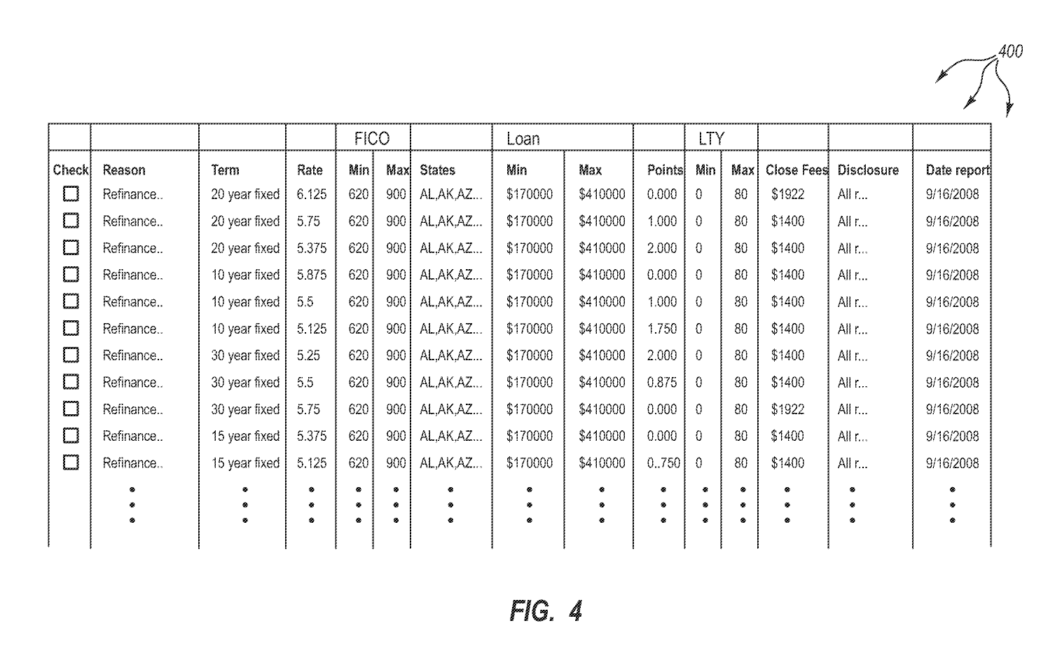

For example, manual input 101A can include a user (e.g., an administrator or database administrator of database 112) interacting directly with database 101A to manually enter financial information data into database 112. Third party pricing system 101C can be a service provider pricing system or an aggregating pricing system that prices financial products for a plurality of different service providers. Third party pricing system 101C can from time to time submit financial product information to database 112. Turning briefly to FIG. 4, FIG. 4 depicts an example of financial product data 400 that can be provided by a third party pricing system.

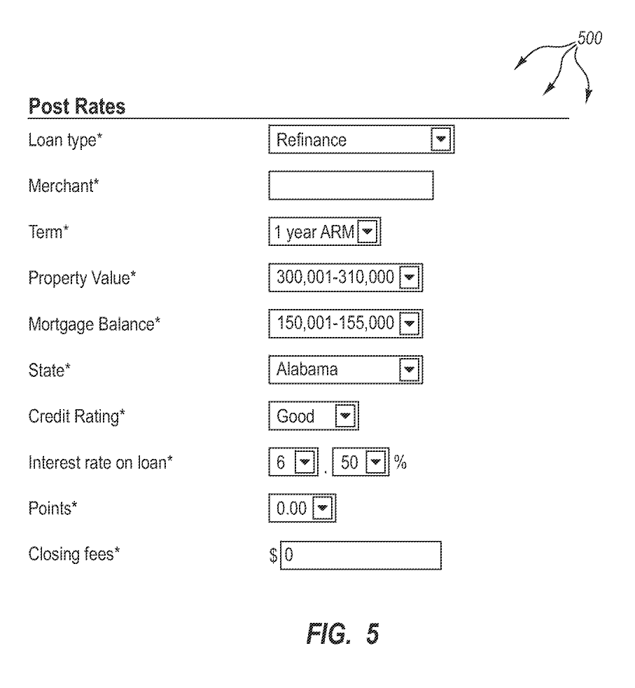

Web scrapping module 101D can implement one or more (e.g., Web) harvesting and/or data extraction techniques to extract financial product information from other computer systems (e.g., service provider Web sites or third party pricing systems) and submit the financial product information to database 112. Consumer supplied data 101F can be entered by consumers and/or potential consumers into a (e.g., Web based) interface for database 112. Turning briefly to FIG. 5, FIG. 5 depicts an example of user interface 500 that can be used by a consumer to enter financial product data into database 112.

Transaction data 101E represents financial product data used in transactions directed to pricing and/or purchasing financial products. Transactional data 101E can include pricing data and/or other terms for purchased financial products. Since transactional data 101E can include information for purchased financial products, transactional data 101E can be used to determine if there is any room for negotiation between offered prices for financial products and purchase prices for financial products. Service providers can, from time to time, submit their transactional data to database 112, or it may be extracted from public or other third party sources without any involvement on the part of said service providers.

File upload 101B represents the upload of a file contained financial product data to database 112. Financial product data can be accumulated in a file (e.g., using any of the previously described mechanisms) and then the file can be uploaded to database 112. For example, a service provider can accumulate financial product data (e.g., transactional data) in a log that is from time to time uploaded to database 112.

FIG. 1C illustrates a more detailed view of portions of computer architecture 100 for providing financial product quotes to a potential consumer. As depicted in FIG. 1C, computer architecture 101 includes potential consumer 131, computer system 141, and financial product data store 174.

Computer system 141 further includes user interface 142, query processing module 143, quote engine 117, and feedback processing module 144. User interface 142 can be a Web based interface configured to interact with Web browsers (or other software). User interface 142 can provide other computer systems with access to the functionality of components included in computer system 141. For example, potential consumer 131 can use a computer system to interact with user interface 142 and access the functionality of query processing module 143, quote engine 117, and feedback processing module 144. The computer system used by potential consumer 131 can include a Web client (browser), a Web widget, or a third-party application configured to interoperate with user interface 142.

Query processing module 143 is configured to receive a quote request from a potential consumer. From a quote request, query processing module 143 can formulate query terms for submission to database financial product data store 174. Financial product data store 174 is configured to receive query terms and return quote data corresponding to (and potentially matching) the query terms. Returned quote data can be received at quote engine 117. From the quote data, quote engine 117 can generate a customized quote list responsive to received query terms. User interface 142 can then return the customized quote list back to the potential consumer.

Financial product data store 174 includes data enhancement module 146 and database 112. Data enhancement module 146 includes filters and/or other modules that can adjust received query terms and/or perform other processing operations based on received query terms to enhance the likelihood of identifying financial products of interest to a potential consumer. For example, in some embodiments, data enhancement module 146 includes one or more other modules that place potential consumers in “buckets” based on received profile information. Since few, if any, consumers have identical profile information, consumers with similar profile information can be grouped into the same bucket. The one or more other modules can identify what are likely to be viewed as non-material differences between profile information and group consumers accordingly. For example, a first potential consumer having a credit score of 801 can be placed in the same bucket with a second potential consumer having a credit score of 804.

In some embodiments, a filer is applied to each criterion in profile information to convert the value to a range. For example, the credit scores 761, 783, and 806 can all be converted into a “760-850” range. Thus, each of the different credit scores 761, 783, and 806 are treated equally for purposes of comparing pricing information (e.g., among three different corresponding consumers).

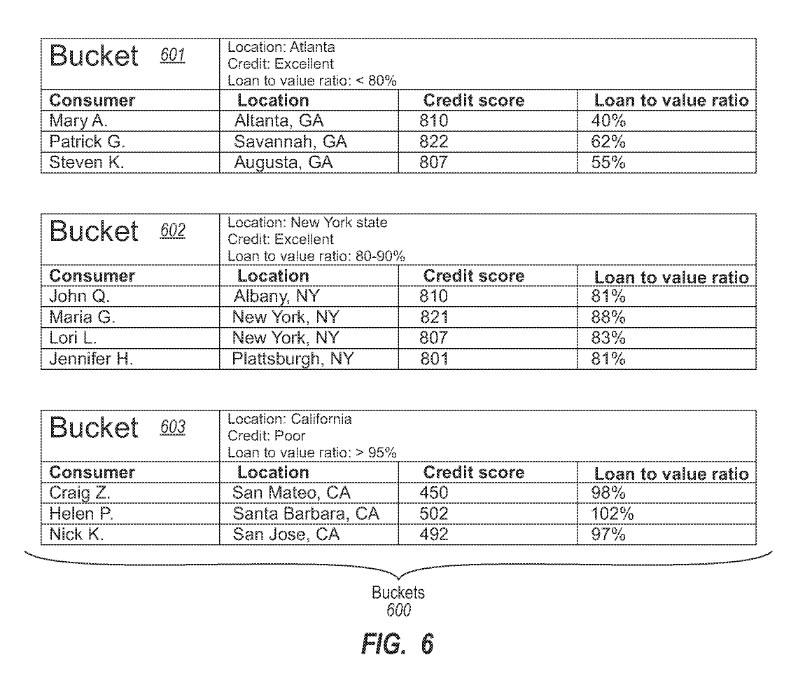

Referring now to FIG. 6, Figure illustrates an example of consumer profile information being placed into buckets 600. One or more modules of data enhancement module 146 can be configured to generate buckets 600. As depicted, buckets 600 include buckets 601, 602, and 603. Buckets 601, 602, and 603 group consumers based on location, credit score, and loan to value ratio. Referring to bucket 601, for example, Mary A., Patrick G., and Steven K., are treated equally for purposes of comparing prices for financial products offered to Mary A., Patrick G., and Steven K. Consumers listed in buckets 602 are similarly treated equally relative to one another for purposes of comparing prices for offered financial products. Consumers listed in buckets 603 are similarly treated equally relative to one another for purposes of comparing prices for offered financial products.

Data enhancement module can also include filters used to interpolate and/or extrapolate probable quotes from known quotes when insufficient data exists. For example, it may be that consumers with a credit score of 760 report having obtained a 5.5% interest rate for a specified financial product and consumers with a credit score of 810 report having obtained a 5% interest rate for the specified financial product. Thus, it can be interpolated that a consumer with a credit score of 785 (i.e., in the range between 760 and 810) may be able to obtain a 5.25% interest rate on the specified financial product. Further it can be extrapolated, that a consumer with a credit score of 835 (outside the range between 760 and 810) may be able to obtain a 4.75% interest rate for the specified financial product.

Feedback processing module 144 is configured to receive scores (e.g., 7/10, 4 stars, etc.) for service providers input providers s, text-based reviews, and price quote inaccuracies (either entered by mistake or with the intention to bait and switch consumers) provided by potential consumers at user interface 142. Feedback processing module can use received scores, text-based reviews, and price inaccuracies to update service provider ratings 153 and/or input provider reputation ratings 154 as appropriate.

For example, when feedback processing module 144 receives a score for a service provider or input provider, feedback processing module 144 can access the current rating for the service provider or input provider. Feedback processing module 144 can adjust the current rating for a service provider or an input provider rating based on the received score to formulate a new rating for the service provider or the input provider respectively. For example, feedback processing module 144 can formulate a new rating by averaging a received score into a current rating.

Further, since many consumers that provide feedback are also information providers, feedback from a particular consumer can be weighted based on the particular consumers input provider rating (e.g., as assigned by other consumers in the community and/or from automated mechanisms). As such, the weight given to feedback received from different consumers can vary based on the different consumers input provider rating.

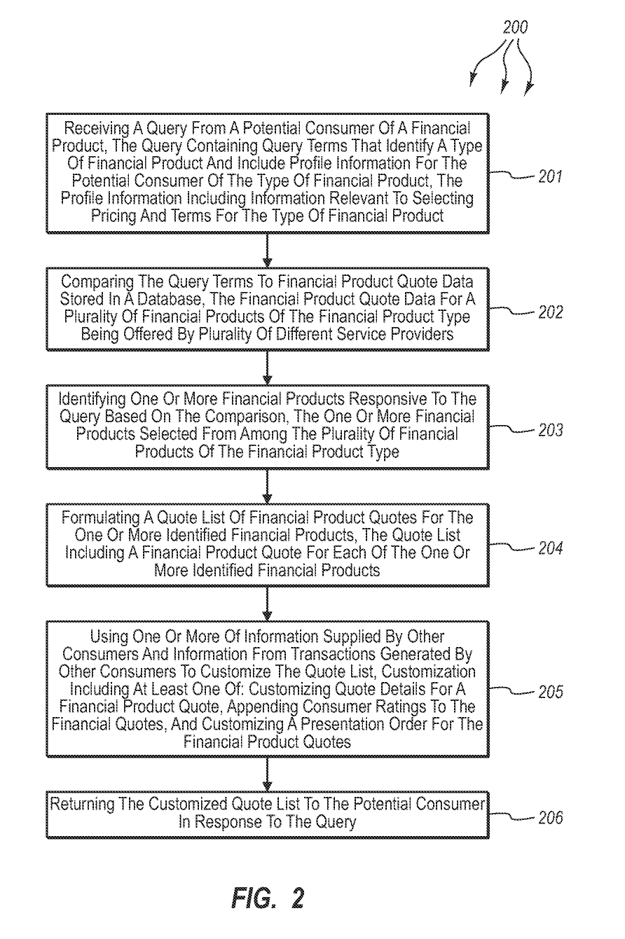

FIG. 2 illustrates a flow chart of an example method 200 for comparing financial products for a potential consumer. Method 200 will be described with respect to the components and data of computer architecture 100.

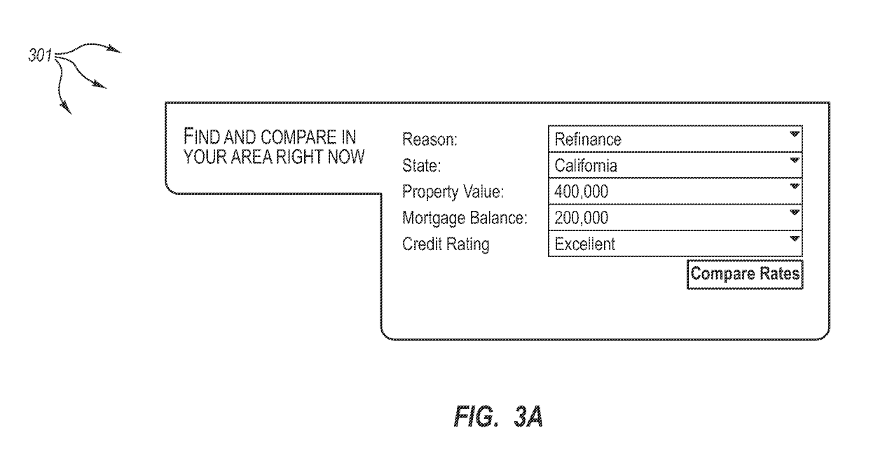

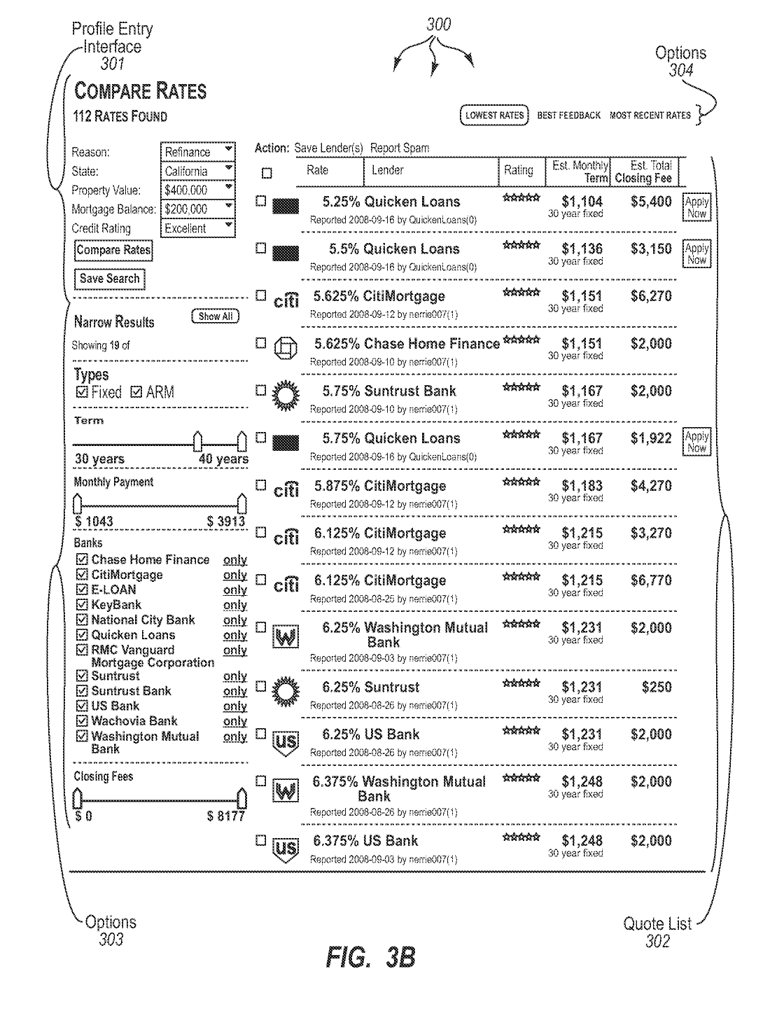

In some embodiments, computer system 141 receives quote request 132 from potential consumer 131. Quote request 132 includes financial product type 133 (e.g., mortgage) and consumer profile 134 (e.g., location, property value, mortgage balance, and credit rating). Potential consumer 131 can manually enter quote request 132, including financial product type 133 and consumer profile 134, into fields provided at user interface 142. Referring briefly to FIG. 3A, FIG. 3A illustrates profile entry interface 301 that potential consumer 131 can use to enter consumer profile 134 at computer system 141.

Query processing module 143 receives quote request 132. From quote request 132, query processing module 143 formulates query terms 158. Computer system 141 then sends query terms 158 to financial product data store 174.

Method 200 includes an act of receiving a query from a potential consumer of a financial product, the query containing query terms that identify a type of financial product and include profile information for the potential consumer of the type of financial product, the profile information including information relevant to selecting pricing and terms for the type of financial product (act 201). For example, financial product data store 174 receives query terms 158 from computer system 141. Data enhancement module 146 performs one or more operations on query terms 158 as appropriate, for example, to group query terms 158 for placement in an appropriate bucket. Data enhancement module 146 then forwards query terms 159 (potentially the same as query terms 158 when data enhancement module 146 does not alter query terms 158) to database 112.

Method 200 includes an act of comparing the query terms to financial product quote data stored in a database, the financial product quote data for a plurality of financial products of the financial product type being offered by plurality of different service providers (act 202). For example, database 112 receives query terms 159. Database 112 compares query terms 159 to financial product data 113, service provider rating data 114, and input provider reputation data 116.

Method 200 includes an act of identifying one or more financial products responsive to the query based on the comparison, the one or more financial products selected from among the plurality of financial products of the financial product type (act 203). For example, database 112 identifies quote data 151 as responsive to quote request 132. Quote data 151 includes pricing data 152, service provider ratings 153, and input provider reputation ratings 154. Pricing data 152 can include prices for one or more offered financial products of financial product type 133. Service provider ratings 153 can include a service provider rating for the service provider offering each of the one or more offered financial products. Input provider reputation ratings 154 can include an input provider reputation rating for the input provider that submitted financial product information to database 112 for each of the one or more offered financial products.

Data enhancement module 146 can interpolate and/or extrapolate portions of pricing data 152 when appropriate.

Database 112 can return quote data 151 to computer system 141. Computer system 141 can receive quote data 151 from database 112. Computer system 141 can forward quote data 151 to quote engine 117.

Method 200 includes an act of formulating a quote list of financial product quotes for the one or more identified financial products, the quote list including a financial product quote for each of the one or more identified financial products (act 204). For example, pricing module 118 can formulate a quote list that includes a quote for each financial product having pricing data in pricing data 152.

Method 200 includes an act of using one or more of information supplied by other consumers and information from transactions generated by other consumers to customize the quote list, customization including at least one of: customizing quote details for a financial product quote, appending consumer ratings to the financial quotes, and customizing a presentation order for the financial product quotes (act 205). For example, quote customization module 162 can use information supplied by other consumers customize the quote list into customized quote list 122. For example, quote customization module 162 can customize individual quotes within customized quote list 122. Quote customization module 162 can also interoperate with rating engine 119 to append server provider and/or information provider ratings to quotes within customized quote list 122. Further, quote customization module 162 can customize the presentation order of quotes within customized quote list 122.

Method 200 includes an act of returning the customized quote list to the potential consumer in response to the query (act 206). For example, quote engine 117 can pass customized quote engine 117 on to user interface 142, which returns customized quote list 122 to potential consumer 131. Customized quote list 122 can then be presented at a computer system used by potential consumer 131. In some embodiments, customized quote list 122 is presented as a results table.

FIG. 3B illustrates an example interface 300 for presenting a list of financial product quotes. As depicted in FIG. 3B, interface 300 includes profile entry interface 301 as well as results table 302, options 303, and options 304. Results table 302 lists a plurality of mortgages, including an interest rate, lender (service provider), a lender rating, estimated monthly payment, and estimated close fees. A potential consumer (e.g., potential consumer 131) can select different combinations of options from options 303 to alter the presentation of results table 302. For example, a potential consumer can select fixed rate and are adjustable rate mortgages, can adjust the term or amortization, can adjust the desired monthly payment, selected and/or selected specific service providers, and adjust desired closing fees.

A potential consumer (e.g., potential consumer 131) can select a different option from options 304 to alter the presentation of results table 302. For example, a potential consumer can select lowest rate to show mortgages with the lowest rate first, can select best feedback to show mortgages from service providers with highest ratings first, or can select most recent rates to show mortgages with the most recently updated rates.

Based information in customized quote list 122, potential consumer 131 may chose to submit ratings for one or more service providers and/or one or more information providers identified in customized quote list 122. For example, potential consumer 131 can submit reputation score 136 to computer system 141. As depicted, reputation score 136 identifiers input provider 137 and assigns score 138 (e.g., 4/10, three starts, etc). When appropriate, reputation score 136 can also include further text-based feedback, potentially explaining reasons for assigning score 138.

Feedback processing module 144 receives reputation score 136. Feedback processing module 144 accesses reputation rating 171 for input provider 137. Reputation rating 171 includes current rating 172 for input provider 137. Feedback processing module integrates score 138 into current rating 172 (e.g., averaging) to formulate new rating 173. Feedback processing module 144 then submits updated reputation rating 174, including new rating 173, for input provider 137 to database 112. When appropriate, any text-based feedback can be stored along with updated reputation rating 174 in database 112.

Accordingly, embodiments of the invention permit potential consumers to compare financial products based on pricing information obtained by other consumers. Collaboration between consumers increases the chances that a particular consumer can locate a financial product with favorable pricing. Further, pricing for financial products can be tailored to a consumer's eligibility (e.g., based on financial profile). Thus, a consumer is presented with more relevant financial products.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method for comparing financial products for a potential consumer, the method comprising:
an act of receiving a query from a potential consumer of a financial product, the query containing query terms that identify a type of financial product and include profile information for the potential consumer of the type of financial product, the profile information including information relevant to selecting pricing and terms for the type of financial product;
an act of the processor comparing the query terms to financial product quote data stored in a database, the financial product quote data for a plurality of financial products of the financial product type being offered by plurality of different service providers;
an act of identifying one or more financial products responsive to the query based on the comparison, the one or more financial products selected from among the plurality of financial products of the financial product type;
an act of formulating a quote list of financial product quotes for the one or more identified financial products, the quote list including a financial product quote for each of the one or more identified financial products;
an act of using one or more of information supplied by other consumers and information from transactions generated by other consumers to customize the quote list, customization including at least one of: customizing quote details for a financial product quote, appending consumer ratings to the financial quotes, and customizing a presentation order for the financial product quotes; and
an act of returning the customized quote list to the potential consumer in response to the query.

2. The method as recited in claim 1, wherein the act of the processor comparing the query terms to financial product quote data stored in a database comprises an act of comparing the query terms to financial product quote data including: financial pricing product data, service provider rating data, and input provider reputation data.

3. The method as recited in claim 2, wherein the act of comparing the query terms to financial product quote data including: financial pricing product data, service provider rating data, and input provider reputation data comprises:
an act of comparing the query terms to financial pricing product data providing pricing data for the plurality of financial products;
an act of comparing the query terms to service provider rating data providing ratings for service providers that provide the plurality of financial products; and
an act of comparing the query terms to input provider reputation data providing ratings for input providers that entered a pricing quote for one of the plurality of financial products into the database.

4. The method as recited in claim 1, wherein the act of the processor comparing the query terms to financial product quote data stored in a database comprises an act of comparing the query terms to financial product quote data that was previously entered into the database by a plurality of different input providers.

5. The method as recited in claim 1, wherein an act of the processor comparing the query terms to financial product quote data stored in a database comprises an act of grouping the query terms into a bucket along with other similar query terms within a specified range of the query terms.

6. The method as recited in claim 5, wherein the act of identifying one or more financial products responsive to the query based on the comparison comprises an act of identifying one or more financial products responsive to the specified range of query terms used to group query terms into the bucket.

7. The method as recited in claim 1, wherein an act of the processor comparing the query terms to financial product quote data stored in a database comprises an act of determining that there is insufficient data to identify financial products responsive to the query; and
wherein the act of identifying one or more financial products responsive to the query based on the comparison comprises an act of performing one of interpolating and extrapolating additional data from existing financial quote data to provides sufficient data to identify financial products response to the query.

8. The method as recited in claim 1, wherein the act of formulating a quote list of financial product quotes for the one or more identified financial products comprises an act of formulating a list of financial product quotes, each financial product quote including: pricing data for the financial product and a service provider rating for the service provider offering the financial product.

9. The method as recited in claim 1, wherein the act of returning the customized quote list comprises an act of returning a quote list that identifies service providers providing the quoted financial products and the price of the quoted financial products.

10. The method as recited in claim 1, further comprising receiving a rating of a service provider from the potential consumer, the rating indicating the potential consumers experience with the service provider.

11. The method as recited in claim 1, wherein the act of returning the customized quote list comprises an act of returning a quote list that indentifies an input provider that provided the information contained in at least one financial product quote.

12. The method as recited in claim 11, further comprising receiving a reputation rating of the input provider from the potential consumer, the reputation rating indicating the trustworthiness of the information contained in the at least one financial product quote.

13. The method as recited in claim 1, wherein the profile information includes one or more of: sex, age, credit score, location, loan to value ratio, debt to income ratio, loan amount, income, for the potential consumer.

14. The method as recited in claim 1, wherein the type of financial product is selected from among: mortgages, home insurance, credit cards, auto loans, life insurance, auto insurance, property insurance, malpractice insurance, and health insurance.

15. The method as recited in claim 1, further comprising:
an act of one or more input providers entering the financial product quote data into the database prior to receiving the query from the potential consumer.

16. The method as recited in claim 15, wherein the one or more input providers are selected from among: manual input, file uploads, third party pricing systems, Web scrapping modules, transactional data, and consumer supplied data.

17. A computer program product for use at a computer system including one or more processors and system memory, the computer program product for implementing a method for comparing financial products for a potential consumer, the computer program product comprise one or more computer storage media having stored thereon computer-executable instructions that, when executed at a processor, cause the computer system to perform the method, including the following:
receive a query from a potential consumer of a financial product, the query containing query terms that identify a type of financial product and include profile information for the potential consumer of the type of financial product, the profile information including information relevant to selecting pricing and terms for the type of financial product;
compare the query terms to financial product quote data stored in a database, the financial product quote data for a plurality of financial products of the financial product type being offered by plurality of different service providers;
identify one or more financial products responsive to the query based on the comparison, the one or more financial products selected from among the plurality of financial products of the financial product type;
formulate a quote list of financial product quotes for the one or more identified financial products, the quote list including a financial product quote for each of the one or more identified financial products;
use one or more of information supplied by other consumers and information from transactions generated by other consumers to customize the quote list, customization including at least one of: customizing quote details for a financial product quote, appending consumer ratings to the financial quotes, and customizing a presentation order for the financial product quotes; and
return the customized quote list to the potential consumer in response to the query.

18. The computer program product as recited in claim 17, wherein computer-executable instructions that, when executed, cause the computer system to compare the query terms to financial product quote data stored in a database comprise computer-executable instructions that, when executed, cause the computer system to comparing the query terms to financial product quote data including: financial pricing product data, service provider rating data, and input provider reputation data.

19. The computer program product as recited in claim 17, wherein computer-executable instructions that, when executed, cause the computer system to formulate a quote list of financial product quotes for the one or more identified financial products comprises computer-executable instructions that, when executed, cause the computer system to formulate a list of financial product quotes, each financial product quote including: pricing data for the financial product and a service provider rating for the service provider offering the financial product.

20. A computer system, the computer system comprising:
one or more processors;
system memory; and
one or more computer storage media having stored there on computer-executable instructions representing a financial product data store, a query processing module, and a quote engine, the financial product data store further including a data enhancement module and a database, wherein the query processing module is configured to:
receive a quote request from a potential consumer;
convert the quote request to query terms that identify a type of financial product and include profile information for the potential consumer of the type of financial product, the profile information including information relevant to selecting pricing and terms for the type of financial product; and
send the query terms to the financial product data store;
wherein the financial product data store is configured to:
receive the query terms from the query processing module;
compare the query terms to financial product quote data stored in a database, the financial product quote data for a plurality of financial products of the financial product type being offered by plurality of different service providers;
identify one or more financial products responsive to the query based on the comparison, the one or more financial products selected from among the plurality of financial products of the financial product type, including one or more of bucketizing the profile information, interpolating additional data, and extrapolating additional data;
formulate a quote list of financial product quotes for the one or more identified financial products, the quote list including a financial product quote for each of the one or more identified financial products; and
return the quote list to the quote engine; and
wherein quote engine is configured to:
receive the quote list from the financial product data store;
use one or more of information supplied by other consumers and information from transactions generated by other consumers to customize the quote list, customization including at least one of: customizing quote details for a financial product quote, appending consumer ratings to the financial quotes, and customizing a presentation order for the financial product quotes; and
return the customized quote list to the potential consumer in response to the quote request.
